(19) United States
(12) Patent Application Publication
(10) Pub. No.: US 2004/0028348 A1
(43) Pub. Date: Feb. 12, 2004

(54) Method and apparatus for assembling optical devices

(76) Inventors: Marie-Claude Cote, Victor, NY (US); Paul Ebeling, Tucson, AZ (US); Jerry W. Kuper, Pittsford, NY (US); William S. Gornall, Fairport, NY (US)

Correspondence Address: Thomas R. FitzGerald, Esq., Suite 210, 16 E. Main St., Rochester, NY, 14614-1803, US

(21) Appl. No.: 10/389,032

(22) Filed: Mar. 14, 2003

Related U.S. Application Data
(60) Provisional application No. 60/364,131, filed on Mar. 15, 2002.

(51) Int. Cl. G02B 6/36

(52) U.S. Cl. 385/88

(57) ABSTRACT

Coarse alignment between either of the sections and the optical device is effected by using a vision subsystem comprising of two video cameras or a single movable camera and a sideview mirror. Coarse alignment is achieved by aligning corresponding corners of a section and the optical device. Then, given that the dimensions and positioning of the ports and the fibers are known, the optical device is translated along two axes to coarsely align its port with the fibers on the section to be attached. Fine alignment is effected by passing an optical signal through the optical device and adjusting the position/orientation of the optical device to maximize the intensity of light output from the output ports. The optical device is placed on a six axis robot and is adjusted to optimize its alignment with either of the input or the output sections.

This application claims priority from U.S. Provisional application No. 60/364,131 filed Mar. 15, 2002.

### FIELD OF THE INVENTION

The present invention relates to the field of manufacturing optical devices and is especially, but not exclusively, applicable to the assembly of optical devices from two or three components.

### BACKGROUND TO THE INVENTION

The increasing use of optical devices in the telecommunications infrastructure of both private and public organizations has led to an increase in the demand for such optical devices. Unfortunately, manufacturing technologies have not kept pace with this demand. One area which needs innovation is the mundane yet important task of assembling optical devices, for example by connecting input and output fiber arrays to the relevant input and output ports of an optical component

Currently, the complexity of optical devices used in optical telecommunications networks has driven efforts to include as much functionality as possible in integrated optical circuits that can be produced using lithographic techniques. The paths for the light that is transmitted into and out of these optical circuits are typically rectangular optical waveguides that are only a few micrometers in width and height. Interconnection between the ends of such waveguide devices and other components in the optical network may require connection to single mode optical fibers with a core diameter of approximately 9 micrometers. With such small dimensions, the optical transmission through the circuit is very dependent on the alignment between the optical fibers and the ends of waveguide channels when the latter are attached to the former to form an optical device.

One common approach to the problem of assembling optical devices, as illustrated in U.S. Pat. No. 5,926,594, uses two multi-axis robots to align an optical device with its input and output fiber arrays. Each fiber array is manipulated by one of the robots, each of which has up to three translational and three rotational degrees of freedom. The optical device is held stationary on a central mount. To align the arrays with the ports of the device before fixing them to it, light of an appropriate wavelength is passed from the input array through the device and into the output array and both of the robots are adjusted to maximize the intensity of this received light.

The problems of the above approach are legion. Up to twelve possible adjustable movements each corresponding to an axis of freedom of a robot need to be coordinated while attempting to obtain an optimized setting. As an example, one position/orientation may be optimum for one axis in that the transmitted intensity of the light is maximum at that setting; however, positioning for eleven other axes need to be manipulated. Also, determining how to initially align the three components to obtain at least a coarse alignment between the components can be quite difficult. Finally, once all the components are properly aligned, the optimum alignment needs to be maintained while adhesive is applied to the components and cured. This maintenance of the alignment can prove difficult as the multiplicity of the components complicates the issue. Ultimately, the simultaneous manipulation and alignment of the components with up to 6 degrees of freedom each produces a three component alignment problem with up to 12 variable movements.

Based on the above, there is a need for a solution which involves reducing the problem to one involving fewer variables and fewer components and is implementable in manufacturing situations.

It is an object of the present invention to overcome or at least mitigate the shortcomings of the prior art or provide an alternative to previous solutions.

### SUMMARY OF THE INVENTION

According to one aspect of the invention, there is provided a method of assembling an optical device package from an optical device, a first section and a second section, the optical device having an input interface and an output interface, the first section and second section being secured to the input interface and the output interface, respectively, the output interface having at least one output port communicating with a corresponding second section port of the second section and the input interface having a least one input port communicating with a corresponding first section port of the first section, the method comprising the steps of:

a) aligning the at least one input port of the optical device with said first section port of the first section by adjusting a position and/or orientation of at least one of the first section and the optical device

b) attaching the first section to the optical device;

c) aligning the at least one output port of the optical device with the second section port of the second section by adjusting a position and/or orientation of the optical device, with the first section attached, relative to the second section; and

d) attaching the second section to the optical device.

According to a second aspect of the invention, a method of assembling an optical device package comprises:

a) holding a first section of the optical device package stationary;

b) aligning an optical device with the first section by adjusting a position and orientation of the optical device;

c) attaching the optical device and the first section together;

d) holding a second section of the optical device package stationary;

e) aligning the optical device with the second section by adjusting the position and orientation of the optical device and attached first section; and

f) attaching the optical device and the second section together.

According to a third aspect of the invention, there is provided apparatus for assembling an optical device package comprising an optical device, a first section and a second section, the optical device having an input interface and an output interface, and the first section and second section being secured to the input interface and the output interface, respectively, and the output interface having at least one output port communicating with a corresponding second section port of the second section and the input interface having a least one input port communicating with a corresponding first section port of the first section, the apparatus comprising:

a first stationary platform carrying the first section of the optical device package;

a second stationary platform carrying the second section of the optical device package;

an adjustable platform carrying the optical device, the adjustable platform being positioned between the first stationary platform and the second stationary platform,

wherein the adjustable platform is adjustable to align the optical device with the first section and the second section in turn by adjusting a relative displacement between the optical device and either of the first section and the second section.

In a preferred embodiment, coarse alignment between either of the first and second sections and the optical device is effected by using a vision subsystem comprising two video cameras providing top and side views, respectively, or a single movable camera and one or more sideview mirrors. Coarse alignment is achieved by aligning corresponding corners of a section and the optical device. Then, given that the dimensions and positioning of the ports and the fibers are known, the optical device is translated along two axes to coarsely align its port with the fibers on the section to be attached.

Fine alignment may be effected by passing an optical signal through the optical device and adjusting the position/orientation of the optical device to maximize the intensity of light output from the output ports. The optical device is placed on a six axis robot and is adjusted to optimize its alignment with either of the first and second sections. Such fine alignment may employ the method disclosed and claimed in a U.S. patent application filed concurrently herewith and claiming priority from U.S. Provisional patent application No. 60/364,109. The contents of this concurrently filed application are incorporated herein by reference.

### BRIEF DESCRIPTION OF THE DRAWINGS

A better understanding of the invention will be obtained by considering the following detailed description of a preferred embodiment which is described, by way of example only, with reference to the following drawings, in which:

FIG. 1 is a perspective schematic view of an apparatus for assembling an optical device package according to one aspect of the invention;

FIGS. 2A and 2B illustrate the dimensions used for providing coarse alignment between an optical device and a section of the optical device package; and

FIGS. 3A, 3B, and 3C, illustrate plan views of different types of completed optical device packages.

### DETAILED DESCRIPTION

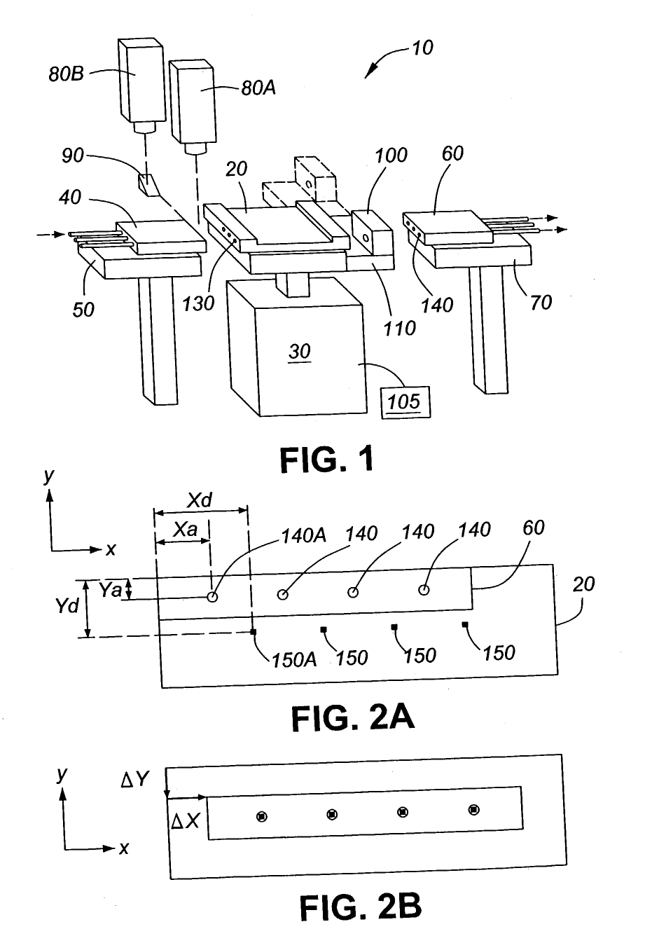

FIG. 1 illustrates a system 10 for assembling optical device packages comprising an optical device 20, a robotic platform 30, a first package section in the form of an input fiber array 40, a first stationary platform 50, a second package section in the form of an output fiber array 60, and a second stationary platform 70. The optical device 20 is placed on the robotic platform 30 which is capable of adjusting position and/or orientation of the optical device along or about any one of 6 axes ( 3 translational axes x, y, and z and 3 rotational axes roll, pitch, and yaw). The input fiber array 40 is placed on the first stationary platform 50 while the output fiber array 60 is placed on the second stationary platform 70. Two video cameras 80A, 80B, along with a side view mirror 90 provide a vision subsystem which is used in approximately aligning the fiber arrays 40 and 60 with the input and output ports, respectively, of the optical device 20. A “first light” detector subsystem 100 is used to optimize alignment between the input fiber array 40 and the optical device 20. The detector subsystem 100, comprising either a photodiode coupled to an optical power meter or a specialized video camera unit, is mounted on a movable platform 110 so that the detector subsystem 100 can be positioned between the optical device 20 and the output fiber array 60, and removed, when not required.

In operation, the system 10 works by first placing the input fiber array 40 in approximate alignment with the relevant ports 130 on an input interface of the optical device 20 using the vision subsystem. This is done by moving the optical device 20 closer to the input fiber array 40 using the platform 30. The separation distance between the input fiber array 40 and the optical device 20 is set by using the camera 80B and the side view mirror 90. An operator can monitor this separation distance using the camera 80B and the side view mirror 90. Once the proper distance is achieved, the movement of the optical device 20 towards the input fiber array 40 is halted and the optical device is fixed at that distance from the input fiber array 40.

After this, one corner of the input fiber array 40 is aligned with a corresponding corner of the optical device 20. This is accomplished by using the vision subsystem again but this time the operator uses the camera 80B and the sideview mirror 90 to monitor a side view of the optical device 20 and input fiber array 40. This sideview mirror 90/camera 80B combination can thus be used to align the top edges of the input fiber array 40 and the optical device 20, respectively.

The side edges of the input fiber array 40 and of the optical device 20 are aligned by adjusting a position of the platform 30 to correspondingly adjust a position of the optical device 20 using the camera 80A. Since the camera 80A provides a top view of the system 10, the operator can use this view to align the side edges of the components. The top view and side view cameras are also used to align the facing horizontal and vertical edges respectively parallel to each other.

Once a corner of the input fiber array 40 is aligned with a corresponding corner of the optical device 20 (e.g. an upper left corner is aligned with a corresponding upper left corner), approximate alignment between the relevant input ports on the optical device 20 and the fibers on the fiber array 40 is relatively simple. This is because the distance between one corner of the optical device 20 and its relevant ports is known, as well as the distance between a corner of the input fiber array 40 and its fibers. Thus, simple translation along two axes (the x and y axes) after taking into account the relevant distances from one of the ports to a corner and from one of the fibers to its corresponding corner, will approximately align the array fibers with the corresponding ports of the optical device 20. In fact, if the input fiber array 40 has a housing with dimensions similar to those of the optical device 20, and if the distances between corners and the relevant fibers/ports are the same, approximate alignment between fibers and ports can be accomplished by merely aligning the relevant corners of the two components. It would also be possible to provide fiducial markings on the optical device 20 and the packaging or housings of the fiber arrays 40 and 60 at predetermined distances from the ports and use the fiduciary marks to provide the coarse alignment of the arrays and the optical device.

To optimize the alignment between the fibers on the input fiber array 40 and the input ports on the optical device 20, an optical source (not shown) is coupled to the input array 40 to pass light into the optical device 20 and the detector subsystem 100 is used to detect light emanating from the output ports of the optical device 20 and measure the intensity of this light. The position of the optical device 20 is then minutely adjusted to maximize the intensity of this light received by the detector 100. Once the intensity is maximized, then the input fiber array 40 is optimally aligned with the optical device 20.

It should be noted that light having specific characteristics, such as a specific wavelength or a broad range of wavelengths, may be used so that an output may be received by the detector 100 at the output ports of the optical device.

The detector 100 can be a photodetector/photodiode sensitive to the output of the optical device 20 and coupled to an optical power meter. The optical power meter measures the intensity of the light received by the photodetector/photodiode. Alternatively, the detector 100 can be a specialized video camera sensitive to the output of the optical device 20. Thus, if the optical device 20 outputs light of a specific wavelength, the photodetector/photodiode or the specialized video camera should be sensitive to this light. If a power meter/photodiode combination is used, an operator can monitor the intensity measurements to determine when a maximum intensity has been achieved. Alternatively, the operator can monitor an output of the specialized video camera to determine maximum intensity. Regarding the adjustments of the platform 30, these can be manually controlled by the operator or they can be specifically programmed into a control computer 105. For more information about such a precision alignment process, the reader is directed to a U.S. patent application filed concurrently herewith and claiming priority from U.S. Provisional application No. 60/364,109, the contents of which are incorporated herein by reference.

When optimum alignment is achieved between the first section fibers and the input ports, an adhesive is applied and cured to secure the input fiber array 40 to the optical device 20. The detector 100 is then removed from between the optical device 20 and the output fiber array 60 and the combined input fiber array 30/optical device 20 is then brought closer to the output fiber array 60. Again using the cameras 80A, 80B and the sideview mirror 90, suitably repositioned, the optical device 20 is brought into approximate or coarse alignment at a specified separation distance with the output fiber array 60. The process is similar to that used for approximate or coarse alignment between the input fiber array 40 and the optical device 20. In essence, two corners are aligned, facing surfaces are made parallel, and a translation along two axes is performed.

FIGS. 2A and 2B illustrate the above described coarse alignment. In FIG. 2A, the image of output fiber array 60 is superimposed upon an image of an end view of the output of optical device 20. The fibers 140 of the output fiber array 60 are to be brought into coarse alignment with the ports 150 of the optical device 20. As can be seen, there is a distance of Xa on the x axis between the first fiber 140A and the corner of the fiber array packaging. Similarly, there is a distance of Xd along the x axis between the corner of the optical device 20 and the first output port 150A. For the y axis, there is a distance of Ya between the first fiber 140A and the corner of the fiber array packaging. For the optical device 20, there is a distance of Yd on the y axis between the first port 150A and the corner of the optical device 20. Thus, the required distances for translation are:

ΔY=Yd−Ya

ΔX=Xd−Xa

These distances can be seen in FIG. 2B. By translating the optical device 20 a distance of ΔX along the x-axis and by a distance of ΔY along the y-axis, coarse alignment between at least the first fiber 140A and the first port 150A and possibly all the fibers 140 and the ports 150 is achieved. This alignment is illustrated in FIG. 2B where the images of the fibers and of the ports are superimposed over one another.

Once coarse alignment is achieved between the optical device 20 and the output section 60, fine alignment between output receiver fibers 140 in the output or second section 60 and the output ports 150 in the optical device 20 is required. This is achieved by again adjusting a position/orientation of the now combined optical device/input section to maximize the intensity of optical signals received by the fibers 140 from the output ports. An optical signal (or multiple optical signals if multiple input ports are involved) is passed through the optical device 20 to be received by the fibers 140. These fibers 140 are coupled to respective output power meters to measure the intensity of any signals received. The position/orientation of the optical device 20 is finely adjusted by adjusting a position/orientation of the robotic platform 30.

When the intensity of the signals received has been maximized, then the alignment between the optical device 20 and the output section 60 is optimized. As with the input section 40, an adhesive is applied between the output section 60 and the optical device 20. This adhesive is thus applied and cured to thereby attach the optical device 20 to the output section 60.

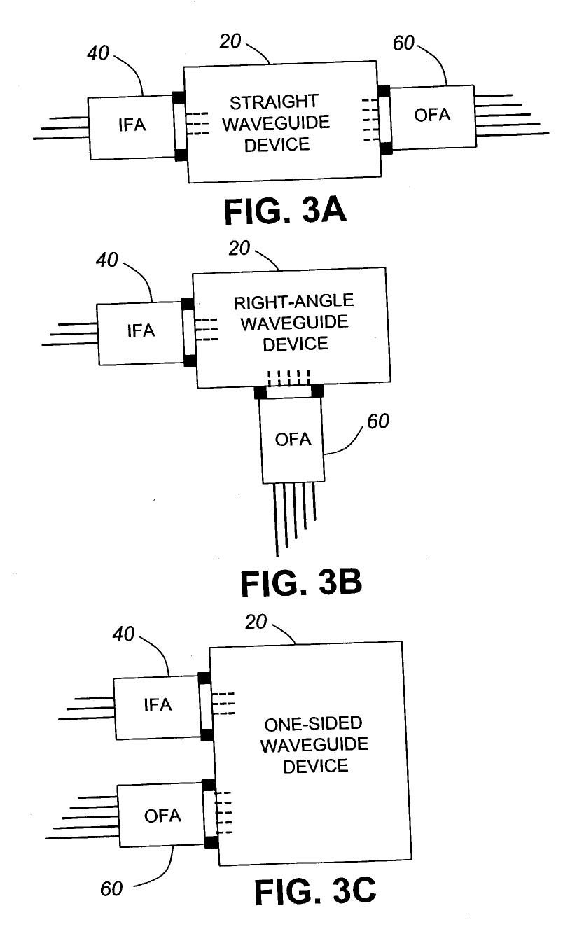

While FIG. 1 illustrates an optical device package that is linear (i.e. all the sections are lined up with each other in a single file), other optical device packages are possible. Even with such non-linear packages, the present invention is applicable. FIGS. 3A, 3B, and 3C, illustrate three examples of possible configurations. FIG. 3A illustrates a completed linear optical device package as shown being assembled in FIG. 1. FIG. 3B illustrates a completed optical device package where the input section 40 is at a right angle to the output section 60. FIG. 3C illustrates a completed optical device package where the input section 40 and the output section 60 are located on a single side of the optical device 20.

The present invention is applicable for all of the configurations described above and others since these optical device packages can be assembled by holding stationary either the input or the output section, adjusting the position/orientation of the optical device to align it with the section being held stationary, fixedly attaching the optical device to this first section, and then repeating the process for the other section, adjusting the position/orientation of the combined first section and optical device.

An advantage of a preferred embodiment of the invention, in which the optical device is mounted on a single six axis robot while the input and output fiber arrays are each held stationary on fixed mounts and secured to the optical device in succession is that the expense of a second robot is avoided and the complications of controlling 12 degrees of movement simultaneously are avoided.

To summarize, the optical device is aligned with the input fiber array by manipulating the position and orientation of the optical device while holding the input fiber array steady and is then attached to the input fiber array. The optical device, with the input fiber array now attached, is then aligned with the output fiber array by manipulating the position and orientation of the optical device. Once aligned, the optical device is then attached to the output fiber array. Alignment between this optical device and the input fiber array is accomplished by using a video camera based system for initially positioning the optical device in line with the input fiber array. Then a photodetector or special video camera sensitive to light emitted from at least one output port of the optical device is used to detect light transmitted through the optical device and the alignment adjusted to maximize its intensity.

Alignment between the optical device and the output array is accomplished in a similar manner by again using the camera based vision system for the initial alignment, and power meters attached to individual fibers on the output fiber array are used to detect the transmitted signal while the alignment is adjusted to maximize its intensity. Although the above-described embodiment uses two cameras, it would be possible to use a single camera mounted upon a gantry and a second angled mirror mounted adjacent the interface between the optical device 20 and the fiber array 60. The gantry would allow the single camera to be moved to the appropriate locations to obtain top and side views of the components to obtain the coarse alignment.

It should be appreciated that, although the assembly of three components to form an optical device has been described hereinbefore, the invention is also applicable to the assembly of only two components to form an optical device.

It should also be noted that the invention is not limited to the assembly of fiber arrays to AWGs as described, but could be applied to other planar waveguide circuit members, such as optical switches, splitters and combiners (one input channel to N output channels and vice versa), pitch converters (N input waveguides with a fixed waveguide spacing to N output waveguides with a different waveguide spacing), polarization controllers (i.e., devices which alter the polarization state of the transmitted light signal), transceivers (normally a single-sided device which has both sources and receivers on the same side of the package) and laser diode pigtailing (alignment of a focusing means and a fiber to a laser diode, where the diode could be in a butterfly, mini-DIL or TO package.

We claim:

1. A method of assembling an optical device package from an optical device, a first section and a second section, the optical device having an input interface and an output interface, the first section and second section being secured to the input interface and the output interface, respectively, the output interface having at least one output port communicating with a corresponding second section port of the second section and the input interface having a least one input port communicating with a corresponding first section port of the first section, the method comprising the steps of:
a) aligning said at least one input port of the optical device with said first section port of the first section by adjusting a position and/or orientation of at least one of the first section and the optical device
b) attaching the first section to the optical device;
c) aligning said at least one output port of the optical device with said second section port of the second section by adjusting a position and/or orientation of the optical device, with the first section attached, relative to the second section; and
d) attaching the second section to the optical device.

2. A method according to claim 1, wherein step a) is accomplished by:
a1) aligning in coarse alignment the at least one input port with the first section port using a first alignment process; and
a2) aligning in fine alignment the at least one input port with the first section port using a second alignment process.

3. A method according to claim 2, wherein step al) is accomplished by aligning one corner of the optical device with a corresponding corner of the first section and translating the optical device along at least one translational axis by a predetermined distance.

4. A method according to claim 2, wherein step a2) is accomplished by:
a2-1) passing an optical signal through the optical device using the first section;
a2-2) receiving the optical signal at a detector, the optical signal being emitted from the at least one output port; and
a2-3) adjusting the position of the optical device to maximize an intensity of the received optical signal.

5. A method according to claim 1, wherein step b) is accomplished by
b1) applying an adhesive between the optical device and the input means; and
b2) curing the adhesive.

6. A method according to claim 1, wherein step c) is accomplished by:
c1) aligning in coarse alignment the at least one output port with the second section port using a first alignment process; and
c2) aligning in fine alignment the at least one output port with the second section port using a second alignment process.

7. A method according to claim 6, wherein step cl) is accomplished by aligning one corner of the optical device of the optical device with a corresponding corner of the second section and translating the optical device along at least one translational axis by a predetermined distance.

8. A method according to claim 6, wherein step c2) is accomplished by:
c2-1) passing an optical signal through the optical device
c2-2) receiving the optical signal at the second section, the optical signal being emitted to the second section by the at least one output port; and
c2-3) adjusting the position of the optical device to maximize an intensity of the optical signal.

9. A method according to claim 1, wherein step d) is accomplished by:
d1) applying an adhesive between the optical device and the second section; and
d2) curing the adhesive.

10. A method according to claim 2, wherein step a1) is accomplished using camera means for providing top and side views of interfaces between the optical device and the first and second sections, respectively.

11. A method according to claim 10, wherein the camera means comprises mirror means adjacent the interfaces and a single camera, and the camera is moved to different positions to provide one of the top and side views directly and the other of the top and side views via the mirror means.

12. A method according to claim 1, wherein the optical device is placed on a robot platform capable of adjusting a position and orientation of the optical device.

13. A method according to claim 12, wherein the robot platform is capable of adjusting the position of the optical device along at least one of the 3 translational axes (x, y, and z axes).

14. A method according to claim 12, wherein the robot platform is capable of adjusting the orientation of the optical device about at least one of the three rotational axes (roll, pitch, yaw).

15. A method of assembling an optical device package, the method comprising:
a) holding a first section of the optical device package stationary;
b) aligning an optical device with the first section by adjusting a position and orientation of the optical device;
c) attaching the optical device and the first section together;
d) holding a second section of the optical device package stationary;
e) aligning the optical device with the second section by adjusting the position and orientation of the optical device; and
f) attaching the optical device and the second section together.

16. Apparatus for assembling an optical device package comprising an optical device, a first section and a second section, the optical device having an input interface and an output interface, and the first section and second section being secured to the input interface and the output interface, respectively, and the output interface having at least one output port communicating with a corresponding second section port of the second section and the input interface having a least one input port communicating with a corresponding first section port of the first section, the apparatus comprising:
a first stationary platform carrying the first section of the optical device package;
a second stationary platform carrying the second section of the optical device package;
an adjustable platform carrying the optical device, the adjustable platform being positioned between the first stationary platform and the second stationary platform,
wherein the adjustable platform is adjustable to align the optical device with the first section and the second section in turn by adjusting a relative displacement between the optical device and either of the first section and the second section.

17. Apparatus according to claim 16, wherein the adjustable platform is a robot platform capable of adjusting position and orientation along at least one of 3 translational axes (x, y, and z axes) or about at least one of 3 rotational axes (roll, pitch, yaw).

18. Apparatus according to claim 17, further including camera means for providing a top view and a side view of interfaces between the optical device and the first and second sections, respectively.

19. Apparatus according to claim 18, wherein the camera means comprises mirror means
adjacent the interfaces and a single camera movable to different positions to provide one of the top and side views directly and the other of the top and side views via the mirror means.

20. Apparatus according to claim 16, wherein the apparatus further includes a subsystem for use in providing fine alignment between the first section and the optical device by passing light through the first section and optical device, detecting light leaving at least one output port of the optical device and monitoring intensity of the detected light while adjusting alignment of the first section and the optical device.

21. Apparatus according to claim 20, wherein the subsystem includes a video camera for detecting an optical signal emitted from the plurality of output ports.

22. Apparatus according to claim 21, wherein the subsystem is mounted on a movable platform which can be placed between the optical device and the second section and then removed.
